(19) United States
(12) Patent Application Publication
(10) Pub. No.: US 2010/0007699 A1
(43) Pub. Date: Jan. 14, 2010

(54) LIQUID EJECTION HEAD UNIT, METHOD FOR MANUFACTURING LIQUID EJECTION HEAD UNIT, AND LIQUID EJECTION APPARATUS

(75) Inventors: Shunsuke Watanabe, Matsumoto-shi (JP); Hiroyuki Hagiwara, Suwa-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/497,416

(22) Filed: Jul. 2, 2009

(30) Foreign Application Priority Data
Jul. 3, 2008 (JP) 2008-174172
Jul. 1, 2009 (JP) 2009-157356

(51) Int. Cl. B41J 2/14; B41J 2/16

(52) U.S. Cl. 347/47

(57) ABSTRACT

There is provided with a liquid ejection head unit, a method for the liquid ejection head unit, and a liquid ejection apparatus in which liquid ejection heads can be positioned with high precision and the liquid ejection heads can easily be replaced.

There are also inclined ink jet printing heads having nozzle rows in which nozzle openings are arranged and a platform mounted with the ink jet printing heads. The platform includes a first reference hole which is formed in each of the ink jet printing heads by photolithography and to which each ink jet printing head is positioned.

This application claims priority to Japanese Patent Application No. 2008-174172, filed Jul. 3, 2008 and to Japanese Patent Application No. 2009-157356, filed Jul. 1, 2009. The entireties of both of the aforementioned applications are incorporated by reference herein.

### BACKGROUND OF THE INVENTION

1. Field of the Invention

The present invention relates to a liquid ejection head unit mounted with a plurality of liquid ejection heads for ejecting a liquid from nozzle openings, a method for manufacturing the liquid ejection head unit, and a liquid ejection apparatus.

2. Invention of Related Art

A liquid ejection apparatus, of which a representative example is an ink jet printing apparatus such as an ink jet printer or a plotter, includes a liquid ejection head unit (hereinafter, also referred to as a head unit) mounted with a plurality of liquid ejection heads capable of ejecting a liquid, such as ink stored in a cartridge or a tank, as liquid droplets.

The plurality of liquid ejection heads is placed on a platform, which is a common holding member, and the plurality of liquid ejection heads is disposed such that nozzle rows in which nozzle openings of each liquid ejection head are arranged and formed continuously in an arrangement direction.

The liquid ejection heads are mounted on the platform, after the relative position of the liquid ejection heads is decided with high precision. There is known a technique for aligning the position of the liquid ejection head with a predetermined reference position by driving an actuator device and moving a parallel plate spring or the like (for example, see Patent Document 1). In addition, there is known a technique for positioning the nozzles of a liquid ejection head to an alignment mark, formed on a glass mask or the like in advance, with high precision (for example, see Patent Document 2).

[Patent Document 1] JP-A-2003-57430 (claim 4, paragraph 0025 and the like)

[Patent Document 2] JP-A-2008-36512 (paragraphs 0086 to 0111, and the like)

In the technique disclosed in Patent Document 1, however, since alignment mechanisms, such as the actuator device or the parallel plate spring, for executing the positioning are disposed in the head unit to be in one-to-one correspondence with the liquid ejection heads, the liquid ejection head unit becomes complicated. Therefore, a problem with the restriction on the miniaturization may arise. Of course, cost is incurred to implement the alignment mechanisms. Moreover, in the technique disclosed in Patent Document 2, since it is necessary to adjust the plurality of liquid ejection heads so as to be positioned to the alignment mark of the glass mask, it takes time to adjust the position of the liquid ejection heads.

### SUMMARY OF INVENTION

According to an aspect of the invention, there is provided a liquid ejection head unit including: liquid ejection heads which each have a nozzle row in which a plurality of nozzle openings is arranged; and a platform which is mounted with the plurality of liquid ejection heads. The platform includes a first reference which is formed in each of the liquid ejection heads by photolithography and to which the liquid ejection head is positioned.

According to this aspect, since the liquid ejection head is positioned to the first reference formed by photolithography, the liquid ejection head can be mounted on the platform with high precision. Just by individually positioning the liquid ejection heads on the platform, the heads can relatively be positioned with high precision.

Here, it is preferable that the platform includes a member which is provided with the first reference and formed in each of the liquid ejection heads. With such a configuration, the degree of freedom with which the first references are mounted on the platform board is improved. Therefore, the relative position between the heads can easily be adjusted depending on the use or the goal. Since the number of members in which the first references are formed can be increased, it is possible to reduce the cost. Moreover, even when the member with the first reference is damaged, it is not necessary to replace the platform and only the damaged member can be replaced. Therefore, it is possible to reduce the cost incurred due to the replacement.

In the liquid ejection head, it is preferable that a second reference which is positioned to the first reference is formed by photolithography. With such a configuration, since the second reference formed by photolithography is also formed in the liquid ejection head and the second reference is positioned to the first reference, the liquid ejection head can be positioned on the platform with higher precision.

It is preferable that the second reference is formed at a position decided on the basis of at least two nozzle openings of the nozzle rows. With such a configuration, the relative position between the nozzle rows or the nozzle openings of the liquid ejection heads can be regulated with high precision.

It is preferable that the liquid ejection head has a nozzle plate in which the nozzle row is formed by photolithography and the second reference is formed in the nozzle plate by photolithography. With such a configuration, the second reference decided on the basis of at least two nozzle openings of the nozzle rows can be formed at a predetermined position with higher precision.

It is preferable that the first reference is a first reference hole formed by photolithography and a positioning pin is inserted into an insertion hole formed in the liquid ejection head and the first reference hole. With such a configuration, the insertion hole and the first reference hole can be positioned by the positioning pin.

It is preferable that the first reference and the second reference are a first reference hole and a second reference hole formed by photolithography, respectively, and a positioning pin is inserted into the first reference hole and the second reference hole. With such a configuration, the first reference hole and the second reference hole can be positioned by the positioning pin.

It is preferable that the first reference is a first reference surface formed by photolithography and a surface of the liquid ejection head comes in contact with the first reference surface. With such a configuration, by bringing the surface of the liquid ejection head into contact with the first reference surface, the surface and the first reference surface can be positioned.

It is preferable that the first reference and the second reference are a first reference surface and a second reference surface formed by photolithography, respectively, and the first reference surface comes in contact with the second reference surface. With such a configuration, by bringing the first reference surface into contact with the second reference surface, the first reference surface and the second reference surface can be positioned.

It is preferable that the second reference is formed in an area opposite to a liquid ejection direction from the nozzle openings of the liquid ejection head. With such a configuration, the second reference is not flush with the nozzle surface in which the nozzle openings are formed, and spaces are formed in the sides of the nozzle openings of the liquid ejection head and below the platform. For example, the spaces can be used as a space where a member such as a roller included in a mechanism transporting an ejection target medium can be placed in a liquid ejection apparatus including the liquid ejection head unit. By disposing the member such as the roller in the spaces, the narrow space can be kept without enlarging the distance between the ejection target medium and the nozzle surface in accordance with the thickness of the member. Therefore, the liquid can be ejected with high precision.

It is preferable that the platform has a support board made of metal. With such a configuration, the strength of the platform is enhanced.

It is preferable that the platform is made of metal. With such a configuration, it is possible to form the platform having durability.

According to another aspect of the invention, there is provided a liquid ejection apparatus including the liquid ejection head unit according to the above aspect.

According to this aspect, it is possible to improve a print quality and embody the liquid ejection apparatus capable of replacing the liquid ejection head with ease.

According to still another aspect of the invention, there is provided a method for manufacturing a liquid ejection head unit including liquid ejection heads which each have a nozzle row in which a plurality of nozzle openings is arranged and a platform which is mounted with the plurality of liquid ejection heads. The method including: forming a first reference in the platform for each of the liquid ejection heads by photolithography; and positioning the plurality of liquid ejection heads to the first references to mount the liquid ejection heads on the platform.

According to this aspect, it is possible to position the liquid ejection head with high precision and manufacture the liquid ejection head unit capable of replacing the liquid ejection head with ease.

### BRIEF DESCRIPTION OF DRAWINGS

FIG. 1 is a schematic perspective view illustrating a head unit according to Embodiment 1 of the invention.

FIG. 2 is a schematic perspective view illustrating a head according to Embodiment 1 of the invention.

FIG. 3 is a plan view illustrating the main elements of the head unit according to Embodiment 1 of the invention.

FIG. 4 is a sectional view illustrating the main elements of the head unit according to Embodiment 1 of the invention.

FIG. 5 is a sectional view illustrating the main elements of the head unit according to Embodiment 1 of the invention.

FIG. 6 is a schematic perspective view illustrating a head according to Embodiment 2 of the invention.

FIG. 7 is a plan view illustrating the main elements of the head unit according to Embodiment 2 of the invention.

FIG. 8 is a sectional view illustrating the main elements of the head unit according to Embodiment 2 of the invention.

FIG. 9 is a plan view illustrating the main elements of a first reference surface and a second reference surface according to Embodiment 2 of the invention.

FIG. 10 is a sectional view illustrating the main elements of the head unit according to Embodiment 2 of the invention.

FIG. 11 is a sectional view illustrating the main elements of a head unit according to Embodiment 3 of the invention.

FIG. 12 is a sectional view illustrating the main elements of a head unit according to Embodiment 4 of the invention.

FIG. 13 is a sectional view illustrating the main elements of a head unit according to Embodiment 5 of the invention.

FIG. 14 is a schematic view illustrating a printing apparatus according to an embodiment of the invention.

I ink jet printing apparatus (liquid ejection apparatus)
1 ink jet printing head unit (liquid ejection head unit)
10 ink jet printing head (liquid ejection head)
11 nozzle opening
12 head main body
13 passage member
14 nozzle row
20, 20A, 20B, 20C, 20D platform
21, 21C, 21D first reference hole
21A-1, 2 first reference surface
21 B first mark
27 positioning member
28 platform board
30, 30A, 30B reference member
31, 31C second reference hole
31A-1, 2 second reference surface
31B secondmark
40 support board
50, 50A positioning pin
60 nozzle plate

### DESCRIPTION OF THE PREFERRED EMBODIMENTS

Hereinafter, the invention will be described in detail according to the best modes.

### Embodiment 1

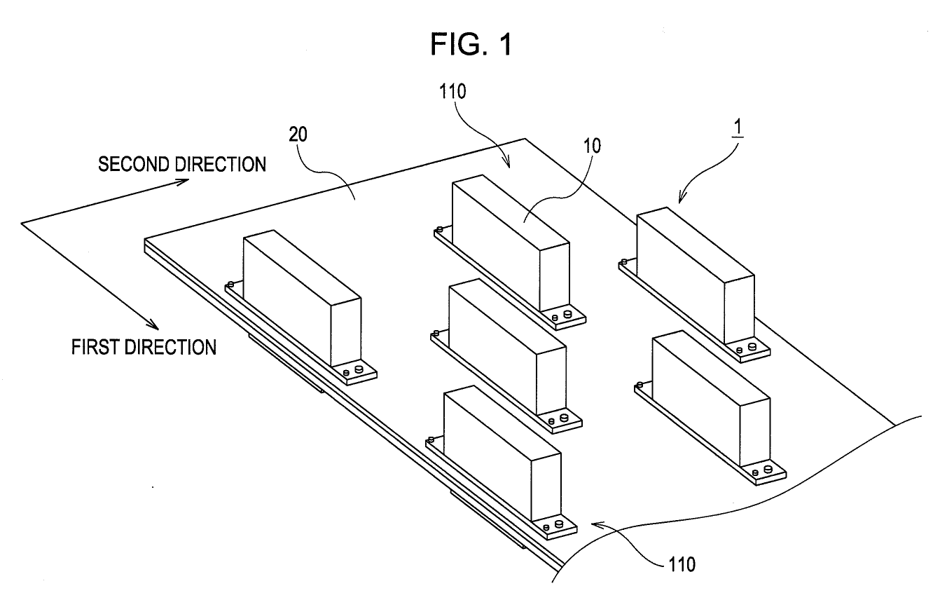

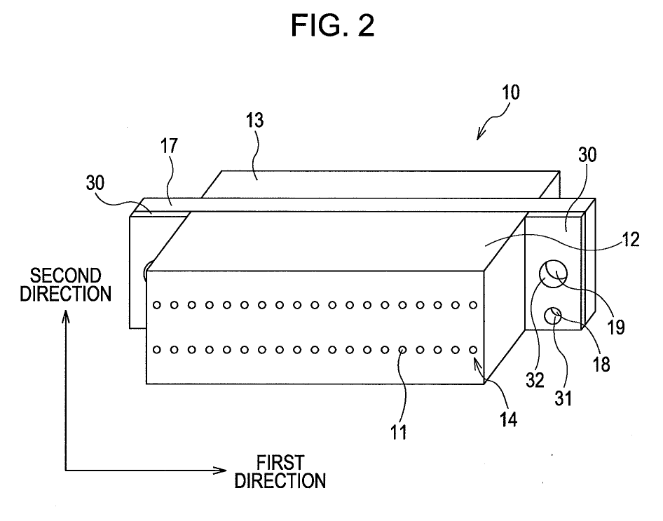

FIG. 1 is a schematic perspective view illustrating an ink jet printing head unit, which is an example of a liquid ejection head unit, according to Embodiment 1 of the invention. FIG. 2 is a schematic perspective view illustrating an ink jet printing head, which is an example of a liquid ejection head, according to Embodiment 1 of the invention.

As shown in FIG. 1, an ink jet printing head unit 1 (hereinafter, also referred to as a head unit) according to this embodiment includes a platform 20 mounted with a plurality of ink jet printing heads 10 (hereinafter, also referred to as a head).

As shown in FIG. 2, the ink jet printing head 10 (hereinafter, also referred to as a head) according to this embodiment includes a head main body 12 in which nozzle openings 11 are formed in one end surface and a passage member 13 fixed to a surface opposite to the surface in which the nozzle openings 11 of the head main body 12 are formed.

The head main body 12 includes nozzle rows 14 in which the nozzle openings 11 are arranged. The number of nozzle rows 14 is not particularly limited. For example, one nozzle row may be formed or two or more nozzle rows, that is, a plurality of nozzle rows may be formed. In this embodiment, two nozzle rows 14 are formed in one head main body 12. In this embodiment, a direction in which the nozzle openings 11 are arranged in the nozzle row 14 is referred to as a first direction. A direction intersecting the first direction is referred to as a second direction. Therefore, the two nozzle rows 14 are arranged in the second direction.

Even though not shown, a pressure generating chamber forming a part of the passage communicating with the nozzle opening 11 and a pressure generating unit for ejecting ink from the nozzle opening by varying the pressure of the pressure generating chamber are disposed inside the head main body 12.

The pressure generating unit is not particularly limited. For example, a pressure generating means using a piezoelectric element made by interposing a piezoelectric material with an electromechanical conversion function between two electrodes may be used. Alternatively, a pressure generating unit may be used in which a heating element is disposed within the pressure generating chamber and the heating element generates bubbles to eject liquid droplets from the nozzle openings 11. Alternatively, a pressure generating unit may be used in which liquid droplets are ejected from the nozzle openings 11 by generating static electricity between a vibration plate and an electrode and deforming the vibration plate by an electrostatic force. As to the piezoelectric element, there may be used a bending vibration type piezoelectric element formed by laminating a lower electrode, a piezoelectric material, and an upper electrode from a pressure generating chamber to implement bending deformation. Alternatively, there may be used a vertical vibration type piezoelectric element formed by alternately laminating a piezoelectric material and an electrode formation material to expand or contract in an axial direction.

The passage member 13 is fixed to a surface opposite to the surface of the nozzle openings 11 of the head main body 12 to supply ink from the outside to the head main body 12 or discharge the ink from the head main body 12 to the outside. Liquid passage ports (not shown) for connecting the open inside passages to the outside passages and a connector (not shown) to which an electric signal such as a print signal is supplied from the outside are formed on a surface of the passage member 13 opposite to the surface to which the head main body 12 is fixed.

Flanges 17 protruding outwardly are formed in both the sides of the head 10 in the first direction. A reference member 30 is disposed on the surface of each of the flanges 17 on the side of the nozzle rows 14. The reference members 30 are formed only in the areas corresponding to the flanges 17 of the head 10, but may be formed in a frame shape surrounding the side surfaces of the head unit 10 as well as the areas corresponding to the flanges 17.

A second reference hole 31, which is an example of a second reference, is formed in the reference member 30 by photolithography. Specifically, the second reference hole 31 is formed at a predetermined position decided on the basis of at least two nozzle openings 11 of the nozzle rows 14. The predetermined position decided on the basis of at least two nozzle openings 11 of the nozzle rows 14 refers to a position which is away from at least two nozzle openings 11 of the nozzle rows 14 by a predetermined distance in the X and Y directions in a plan view of the head 10 from the nozzle rows 14. The predetermined distance is common to all of the heads 10. Therefore, as described below, when the second reference holes 31 are positioned to first reference holes 21, the nozzle rows 14 are arranged while maintaining a relative position relationship between the first reference holes 21.

The second reference holes 31 are an example of an area formed opposite to an ink ejection direction from the nozzle openings 11 of the head 10 and are formed in the reference members 30 formed in the flanges 17, respectively. That is, the second reference holes 31 are not flush with a nozzle surface of the nozzle rows 14. Therefore, spaces are formed on the sides of the nozzle rows 14 of the head 10 and below a support board 40. In the ink jet printing apparatus including the head unit 1, for example, these spaces can be used as a space where a member such as a roller included in a sheet discharging mechanism is disposed. With such a configuration, a gap between a sheet and the nozzle surface is prevented from becoming wide when the member is interposed in the gap. Moreover, by keeping this gap narrow, high precise printing can be performed.

The second reference holes 31 are formed by forming a photoresist pattern with openings having the same shape as that of the first reference hole 21 at the predetermined position decided on the basis of at least two nozzle openings 11 of the nozzle rows 14 on the reference member 30, and then etching the photoresist pattern.

The shape of the opening of the second reference hole 31, even though the details are described below, is circumscribed with the outer circumferential surface of a positioning pin 50, when the positioning pin 50 is inserted into the opening. An insertion hole 18 communicating with the second reference hole 31 is formed in the flange 17. The opening of the insertion hole 18 is larger than the opening of the second reference hole 31. Therefore, the positioning pin 50 does not come in contact with the insertion hole 18. That reason is to prevent the positioning pin 50 from being restrained at the insertion hole 18, if the opening of the insertion hole 18 is smaller than that of the second reference hole 31.

In this embodiment, the reference member 30 is made of silicon, but the material is not particularly limited, as long as the second reference material 31 can be made of the material by photolithography. Examples of the material include metal such as SUS and an etching material such as glass.

A mounting hole 32 communicating with the mounting hole 19 formed in the flange 17 is formed in the reference member 30. The flanges 17 are fixed to the platform 20 by fixing screws 51 inserted into the mounting holes 19 and 32.

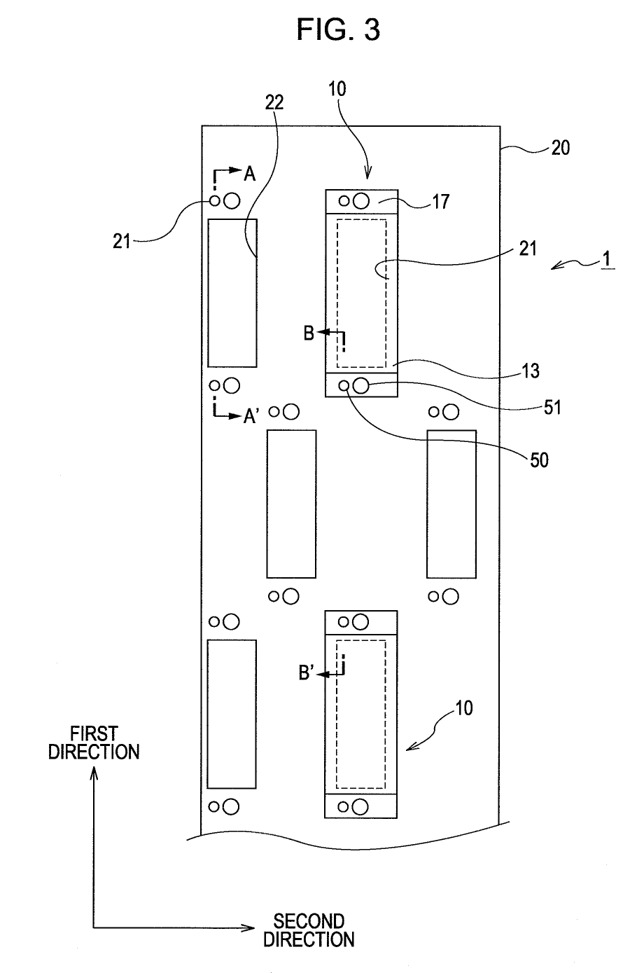

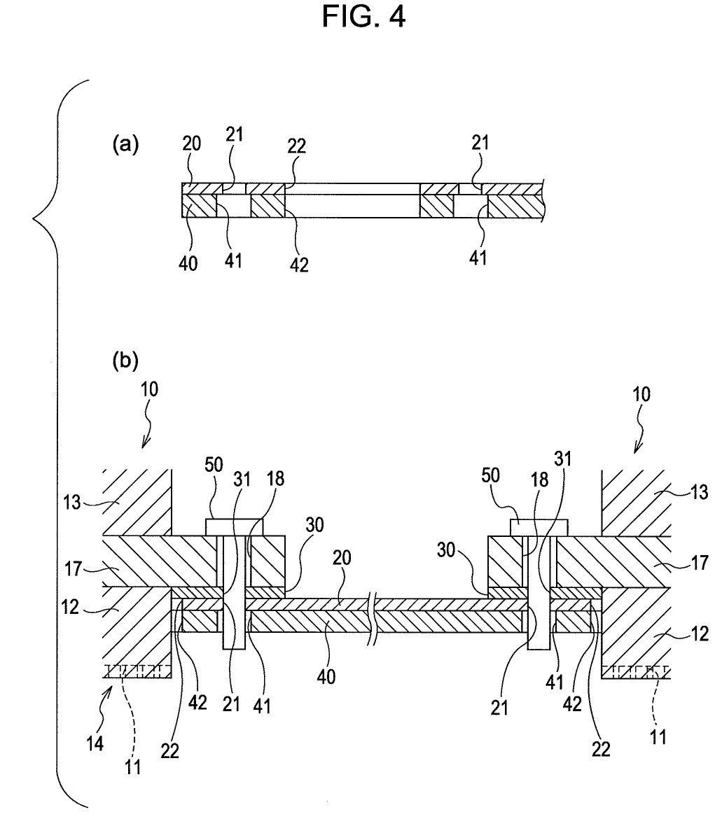

FIG. 3 is a plan view illustrating the ink jet printing head unit on the side of the passage member according to Embodiment 1 of the invention. (a) of FIG. 4 is a sectional view taken along the line A-A′ of FIG. 3. (b) of FIG. 4 is a sectional view taken along the line B-B′ of FIG. 3.

The platform 20 will be described in detail with reference to FIG. 3 and (a) of FIG. 4. As illustrated, in the platform 20, a support board 40 made of metal is formed on the surface of the nozzle rows 14. Therefore, the strength of the platform 20 made of silicon is enhanced. In the platform 20, one holding hole 22 is formed for one head 10. In the support board 40, a board-side holding hole 42 is formed so as to communicate with the holding hole 22.

The holding hole 22 of the platform 20 and the board-side holding hole 42 of the support board 40 are slightly larger than the outer circumference of the head 10 on the side of the nozzle rows 14 and are formed as an opening smaller than the flanges 17. Therefore, when the head 10 is inserted into the holding hole 22 and the board-side holding hole 42, the flanges 17 of the head 10 are held in the platform 20. Since a gap is formed between the head 10, the holding hole 22, and the board-side holding hole 42, the head 10 can slightly move with respect to the platform 20 in the first and second directions.

In the platform 20, two first reference holes 21 (first reference) are formed for one head 10 at predetermined positions by photolithography. Here, the fact that the first reference holes 21 are formed at the predetermined positions means that when the second reference holes 31 are positioned to the first reference holes 21, the first reference holes 21 are formed in the platform 20 so that the relative position of the plurality of heads 10 becomes a predetermined arrangement state. That is, when the first reference holes 21 are formed at the predetermined positions and the second reference holes 31 are positioned to the first reference holes 21, the heads 10 are mounted on the platform 20 in the predetermined arrangement state. At this time, since the second reference holes 31 are formed on the basis of at least two nozzle openings 11 of the nozzle rows 14, as described above, the nozzle rows 14 are arranged, while maintaining the relative position of the heads 10.

The first reference holes 21 are formed by forming a predetermined photoresist pattern by photolithography on the platform 20 formed of a silicon plate-shaped member, and then etching the photoresist pattern.

Since at least one of the opening shape of the first reference hole 21 and the opening shape of the second reference hole 31 is the same as the shape of the positioning pin 50 in a plan view, the outer circumferential surface of the positioning pin 50 upon inserting the positioning pin 50 comes in contact with the wall surface of the first reference hole 21 or the wall surface of the second reference hole 31. Alternatively, when the opening shape of the first reference hole 21 or the opening shape of the second reference hole 31 is not the same as the shape of the positioning pin 50 in a plan view, the opening shape of the first reference hole 21 or the second reference hole 31 may be parallelogram, for example. In this case, when the positioning pin 50 is inserted, the positioning pin 50 comes in contact with a plurality of points on the wall surface of the first reference hole 21 or the second reference hole 31. In short, the opening shape of the first reference hole 21 or the second reference hole 31 may be formed so that the positioning pin 50 comes in contact with the wall surface of the first reference hole 21 or the second reference hole 31 and the movement is regulated in a radial direction in a reference hole of the positioning pin 50. On the other hand, an insertion hole 41 communicating with the first reference hole 21 is formed in the support board 40. The opening of the insertion hole 41 is larger than the opening of the first reference hole 21. Accordingly, the positioning pin 50 does not come in contact with the insertion hole 18. That reason is to prevent the positioning pin 50 from being restrained at the insertion hole 41, if the opening of the insertion hole 41 is smaller than that of the first reference hole 21.

In this embodiment, the platform 20 is made of silicon, but the material is not particularly limited, as long as the first reference hole 21 can be made of the material by photolithography. Examples of the material include metal such as SUS and an etching material such as glass.

The positioned head will be described with reference to (b) of FIG. 4. As illustrated, the side of the nozzle rows 14 of the head 10 is inserted into the holding hole 22 and the board-side holding hole 42, and the flanges 17 are held on the platform 20 with the reference members 30 interposed therebetween.

The positioning pin 50 is inserted into the insertion holes 18, the second reference holes 31, the first reference holes 21, and the insertion holes 41, the fixing screws 51 are inserted into the mounting holes 19 and 32 (see FIG. 2), and the flanges 17 are fixed to the platform 20 by the fixing screws 51 (see FIG. 3).

As described above, the inner circumferential surface of the opening shape of the first reference hole 21 and the second reference hole 31 come in contact with the outer circumferential surface of the positioning pin 50. On the other hand, since the first reference holes 21 and the second reference holes 31 are formed by photolithography, a size tolerance is smaller, compared to a case of forming resin by injection molding. Accordingly, when the positioning pin 50 is inserted into the first reference hole 21 and the second reference hole 31, the first reference hole 21 and the second reference hole 31 are positioned with high precision. As a consequence, each head 10 can be disposed in the first reference holes 21 of the platform 20 with high precision.

The second reference hole 31 is formed on the basis of at least two nozzle openings 11 of the nozzle rows 14. Therefore, when the second reference hole 31 is positioned to the first reference hole 21, the nozzle rows 14 are also positioned to the first reference hole 21 with high precision. Accordingly, due to this positioning, the relative position of the nozzle rows 14 of the head 10 can be regulated with high precision.

In this embodiment, the arrangement of the heads 10 at predetermined positions is as follows. That is, as shown in FIG. 1, the plurality of heads 10 are arranged in the first direction, which is the arrangement direction of the nozzle openings 11 of the nozzle rows 14 (see FIG. 2) of the head 10, to constitute head groups 110. Four head groups 110 are arranged in the second direction. That is, the plurality of heads 10 is arranged in the first and second directions.

Specifically, the plurality of heads 10 is disposed in a zigzag shape in the first direction so that the nozzle rows 14 are continuously arranged in the first direction. In addition, two head groups 110 constituted by the plurality of heads 10 disposed so that the nozzle rows 14 are continuously arranged in the first direction are disposed in the second direction.

Here, the fact that the nozzle rows 14 of each head group 110 are continuously arranged in the first direction means that the nozzle openings 11 in the end of the nozzle rows 14 of one head 10 of the heads 10 adjacent to each other in the second direction in each head group 110 and the nozzle openings 11 in the end of the nozzle rows 14 of the other head 10 are arranged at the same positions in the first direction.

In this way, by continuously arranging the nozzle rows 14 of the plurality of heads 10 in the first direction in each head group 110, wide-range printing can be performed at a high speed, compared to a case where printing is performed using the nozzle rows 14 of one head 10.

In the head unit 1 according to this embodiment, as described above, the positioning of each head 10 to the platform 20 can be performed with high precision and with ease just by inserting the head 10 into the holding hole 22 and then inserting the positioning pins 50 into the first reference holes 21 and the second reference holes 31. In a known example, when the head 10 is positioned at the predetermined position, fine adjustment is required using an actuator device or an alignment mask. However, in the head unit 1 according to this embodiment, these devices or the process are not required. Moreover, since the alignment mechanisms used in the known example are not required in the head unit 1, the size of the head unit 1 can be reduced. Due to the facilitation of the positioning, a work for replacing the head 10 can be carried out easily in a place where the liquid ejection apparatus including the head unit 1 is used. That is because the head 10 is positioned with high precision and then can be individually replaced without exchanging the head unit 1.

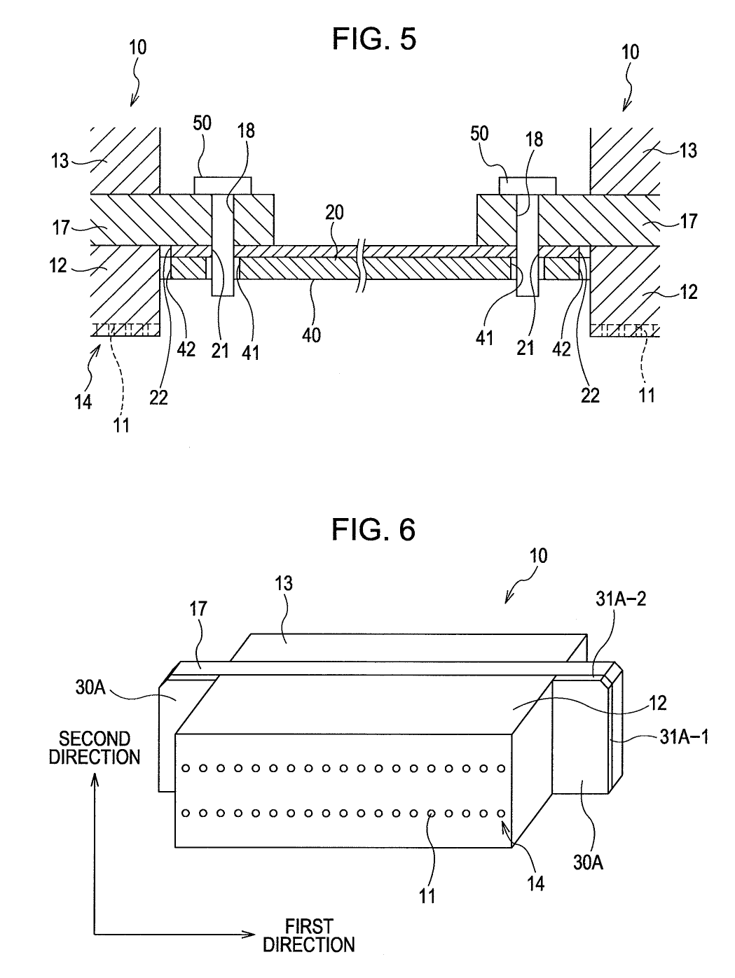

In this embodiment, the second reference hole 31 is formed by photolithography, but the invention is not limited thereto. A head unit in a case where only the first reference holes 21 are formed by photolithography will be described with reference to FIG. 5. FIG. 5 is a sectional view illustrating the head unit.

As illustrated, the reference members 30 are not disposed on the flanges 17 of the head 10 and the insertion holes 18 of the flanges 17 serve as the second reference. The positioning pins 50 are inserted into the insertion holes 18, the first reference holes 21, and the insertion holes 41. The flanges 17 are directly held on the platform 20. Even in this case, since the insertion holes 18 are positioned to the first reference holes 21 formed by photolithography through the positioning pins 50, the head 10 can be mounted on the platform 20 with high precision, even though the head 10 is not mounted with high precision to the degree that the reference members 30 having the second reference hole 31 are disposed.

### Embodiment 2

FIG. 6 is a schematic perspective view illustrating an ink jet printing head which is an example of a liquid ejection head according to Embodiment 2. The same reference numerals are given to the same constituent elements as those of Embodiment 1, and the repeated description is omitted.

As illustrated, reference members 30A are disposed on the surface of the flanges 17 on the side of the nozzle rows 14.

Second reference surfaces 31A-1 and 31A-2, which are an example of the second reference, are formed on the reference member 30A by photolithography. The second reference surface 31A-1 is a side surface of the reference member 30A in the first direction and the second reference surface 31A-2 is a side surface adjacent to the side surface.

Specifically, the second reference surfaces 31A-1 and 31A-2 are formed on the basis of at least two nozzle openings 11 of the nozzle rows 14. A predetermined position decided on the basis of at least two nozzle openings 11 of the nozzle rows 14 refers to a position which is away from at least two nozzle openings 11 of the nozzle rows 14 by a predetermined distance in the X and Y directions in a plan view of the head 10 from the nozzle rows 14, as in Embodiment 1. The predetermined distance is common to all of the heads 10. Therefore, as described below, when the second reference surfaces 31A-1 and 31A-2 come in contact with the first reference surfaces 21A-1 and 21A-2, the nozzle rows 14 are arranged while maintaining a relative position relationship between the first reference surfaces 21A-1 and 21A-2.

The second reference surfaces 31A-1 and 31A-2 are an example of an area formed opposite to an ink ejection direction from the nozzle openings 11 of the head 10 and are formed in each of the flanges 17. That is, the second reference surfaces 31A-1 and 31A-2 are not flush with a nozzle surface of the nozzle rows 14. Therefore, spaces are formed on the sides of the nozzle rows 14 of the head 10 and below a support board 40. In the ink jet printing apparatus including the head unit 1, for example, these spaces can be used as a space where a member such as a roller included in a sheet discharging mechanism is disposed. With such a configuration, a gap between a sheet and the nozzle surface is prevented from becoming wide when the member is interposed in the gap. Moreover, by keeping this gap narrow, high precise printing can be performed.

The second reference surfaces 31A-1 and 31A-2 are formed by forming a photoresist pattern with a predetermined shape at the predetermined position decided on the basis of at least two nozzle openings 11 of the nozzle rows 14 on the reference member 30A so that the second reference surfaces 31A-1 and 31A-2 are shown, and then etching the photoresist pattern. The second reference surface 31A-1 is perpendicular to the second reference surface 31A-2 and the corners in the boundary are eliminated.

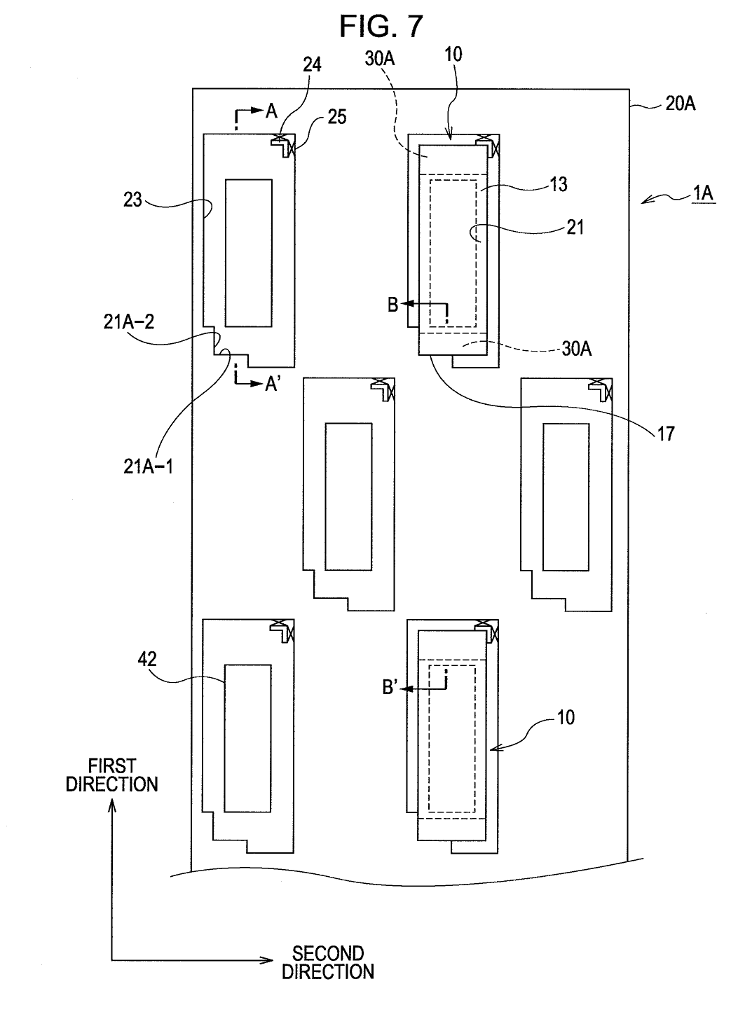

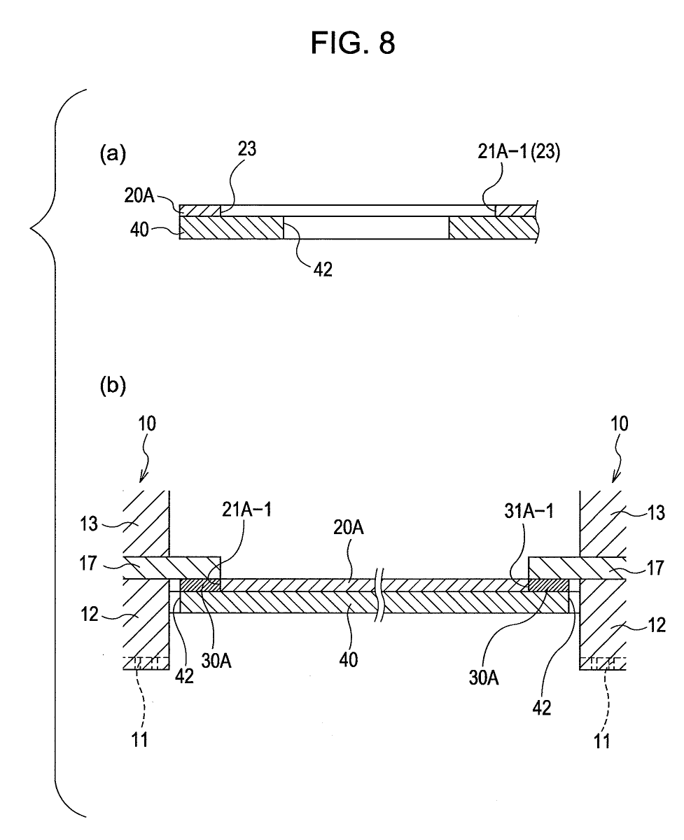

FIG. 7 is a plan view illustrating the ink jet printing head unit on the side of the passage member according to Embodiment 2 of the invention. (a) of FIG. 8 is a sectional view taken along the line A-A′ of FIG. 7. (b) of FIG. 8 is a sectional view taken along the line B-B’ of FIG. 7.

A platform 20A will be described in detail with reference to FIG. 7 and (a) of FIG. 8. As illustrated, in the platform 20A, a support board 40 made of metal is formed on the surface of the nozzle rows 14. Therefore, the strength of the platform 20 made of silicon is enhanced. In the platform 20A, one opening 23 is formed for one head 10. In the support board 40, a board-side holding hole 42 is formed so as to communicate with the opening 23.

The opening 23 of the platform 20 is larger than flange 17 and the board-side holding hole 42 of the support board 40 is slightly larger than the outer circumference of the head 10 on the nozzle rows 14 and is smaller than the flange 17. Therefore, when the head 10 is inserted into the opening 23 and the board-side holding hole 42, a gap is formed between the head 10, the opening 23, and the board-side holding hole 42. Therefore, the head 10 can slightly move with respect to the platform 20A in the first and second directions.

In the platform 20A, the first reference surfaces 21A-1 and 21A-2, which are the first reference, are formed for one head 10 by photolithography. In this embodiment, the first reference surfaces 21A-1 and the 21A-2 are formed as a part of the inner circumferential surface of the opening 23 of the platform 20A at predetermined positions. The fact that the first reference surfaces 21A-1 and 21A-2 are formed at the predetermined positions means that when the second reference surfaces 31A-1 and 31A-2 come in contact with the first reference surfaces 21A-1 and 21A-2, the first reference surfaces 21A-1 and 21A-2 are formed in the platform 20 so that the relative position of the plurality of heads 10 becomes a predetermined arrangement state. That is, when the first reference surfaces 21A-1 and 21A-2 are formed at the predetermined positions of the inner circumferential surface of the opening 23 and the second reference surfaces 31A-1 and 31A-2 come in contact with the first reference surfaces 21A-1 and 21A-2, the heads 10 are mounted on the platform 20A at the predetermined positions. At this time, since the second reference 31A-1 and 31A-2 are formed on the basis of at least two nozzle openings II of the nozzle rows 14, as described above, the nozzle rows 14 are arranged, while maintaining the relative position of the heads 10.

The first reference surfaces 21A-1 and 21A-2 are formed simultaneously with the opening 23 and formed by forming a predetermined photoresist pattern by photolithography on the platform 20A formed of a silicon plate-shaped member, and then etching the photoresist pattern. In this embodiment, the first reference surface 21A-1 is perpendicular to the first reference surface 21A-2.

An urging member 24 is disposed in the region opposite to the first reference surfaces 21A-1 and 21A-2 in the inner circumference surface of the opening 23 with plate springs 25 interposed therebetween.

The positioned head 10 will be described with reference to FIG. 7 and (b) of FIG. 8. As illustrated, the side of the nozzle rows 14 of the head 10 is inserted into the opening 23 and the board-side holding hole 42, and the flanges 17 are held on the support board 40 with the reference members 30A interposed therebetween. The head 10 is pressed in the first reference surfaces 21A-1 and 21A-2 through the urging member 24 by the plate spring 25.

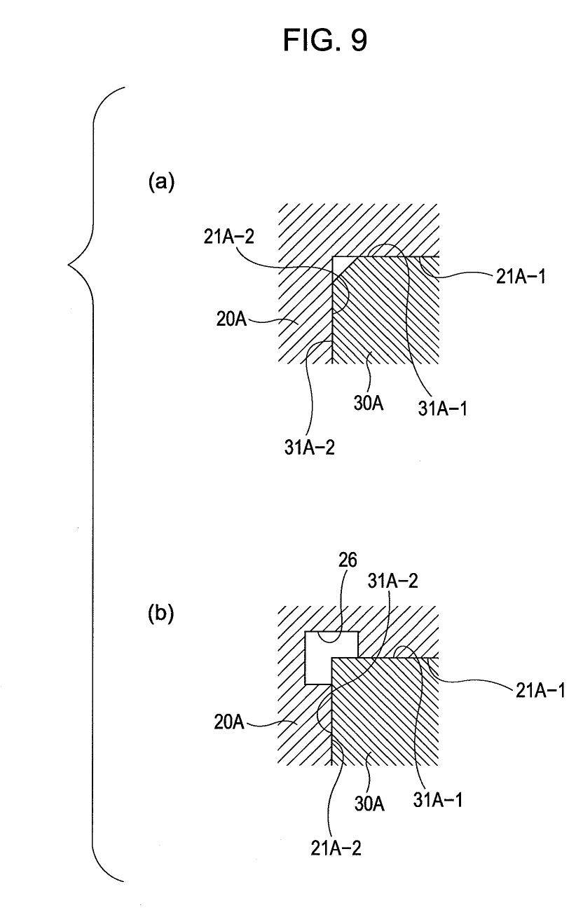

FIG. 9 is a diagram illustrating the main elements of the first reference surface and the second reference surface. As shown in (a) of FIG. 9, the second reference surface 31A-1 comes in contact with the first reference surface 21A-1 and the second reference surface 31A-2 comes in contact with the first reference surface 21A-2. The corner in the boundary between the first reference surfaces 21A-1 and 21A-2 is eliminated. That is because the first reference surface may not come in close contact with the second reference surface due to a burr caused in the corner, when the corner remains upon forming the reference member 30. By eliminating the corner, the first reference surface can come in close contact with the second reference surface. In order to avoid the influence of the burr or the like, as shown in (b) of FIG. 9, a clearance section 26 may be formed to bring the corner of the reference member 30A into contact with the region between the first reference surfaces 21A-1 and 21A-2. With such a configuration, even when the corner of the boundary between the second reference surfaces 31A-1 and 31A-2 is not eliminated, the corner does not come in contact with the first reference surfaces 21A-1 and the 21A-2. Therefore, even when the burr or the like occurs in the corner, the first reference surfaces 21A-1 and 21A-2 can come in close contact with the second reference surfaces 31A-1 and 31A-2, respectively.

Since the first reference surfaces 21A-1 and 21A-2 and the second reference surfaces 31A-1 and 31A-2 are formed by photolithography, as described above, a size tolerance is smaller, compared to a case of forming resin by injection molding. Accordingly, when the second reference surfaces 31A-1 and 31A-2 come in contact with the first reference surfaces 21A-1 and 21A-2, each head 10 can be disposed on the platform 20A with high precision.

The second reference surfaces 31A-1 and 31A-2 are formed on the basis of at least two nozzle openings II of the nozzle rows 14. Therefore, the second reference surfaces 31A-1 and 31A-2 come in contact with the first reference surfaces 21A-1 and 21A-2, the nozzle rows 14 are also positioned to the first reference surfaces 21A-1 and 21A-2 with high precision. Accordingly, due to this positioning, the relative position of the nozzle rows 14 of the head 10 can be regulated with high precision.

In the head unit 1 according to this embodiment, as described above, the positioning of each head 10 to the platform 20 can be performed with high precision and with ease just by inserting the head 10 into the opening 23 and the board-side holding hole 42 and then pressing the head 10 through the urging member 24 by the plate spring 25. In a known example, when the head 10 is positioned at the predetermined position, fine adjustment is required using an actuator device or an alignment mask. However, in the head unit 1 according to this embodiment, these devices or the process are not required. Moreover, since the alignment mechanisms used in the known example are not required in the head unit, the size of the head unit 1 can be reduced. Due to the facilitation of the positioning, a work for replacing the head 10 can be carried out easily in a place where the liquid ejection apparatus including the head unit 1 is used. That is because the head 10 is positioned with high precision and then can individually be replaced without exchanging the head unit 1.

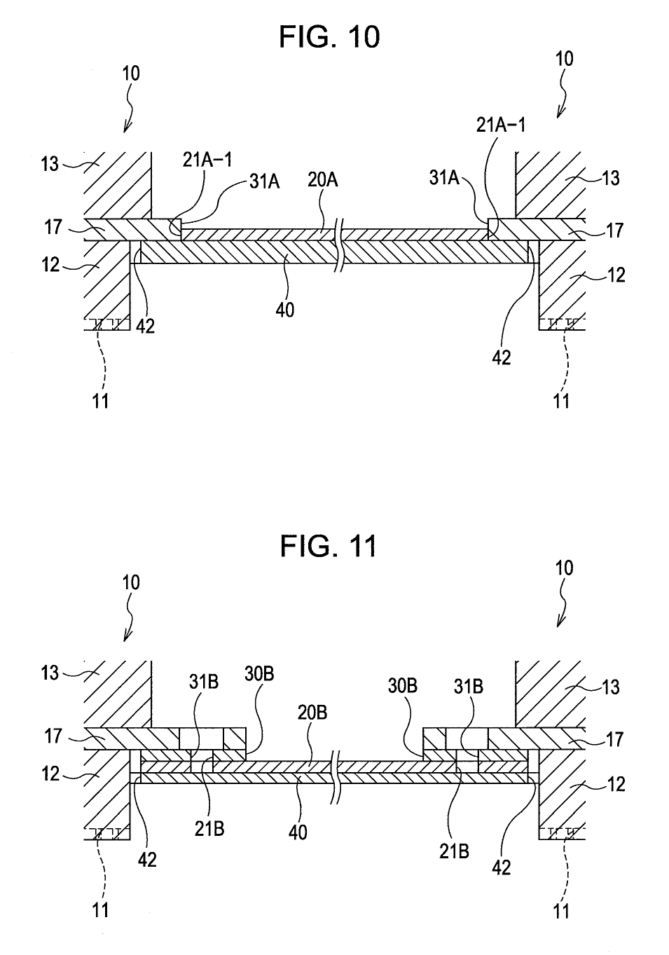

In this embodiment, the second reference surfaces 31A-1 and 31A-2 are formed by photolithography, but the invention is not limited thereto. A head unit in a case where only the first reference surfaces 31A-1 and 31A-2 are formed by photolithography will be described with reference to FIG. 10. FIG. 10 is a sectional view illustrating the head unit.

As illustrated, the reference members 30A are not disposed on the flanges 17 of the head 10 and the side surfaces of the flanges 17 are used as the second reference surface 31A. Even in this case, since the second reference surfaces 31A-1 and 31A-2, which are the side surfaces of the flanges 17 come in contact with the first reference surfaces 21A-1 and 21A-2 formed by photolithography, the head 10 can be mounted on the platform 20 with high precision, even though the head is not mounted with high precision to the degree that the reference members 30A having the second reference surfaces 31A-1 and 31A-2 are disposed.

### Embodiment 3

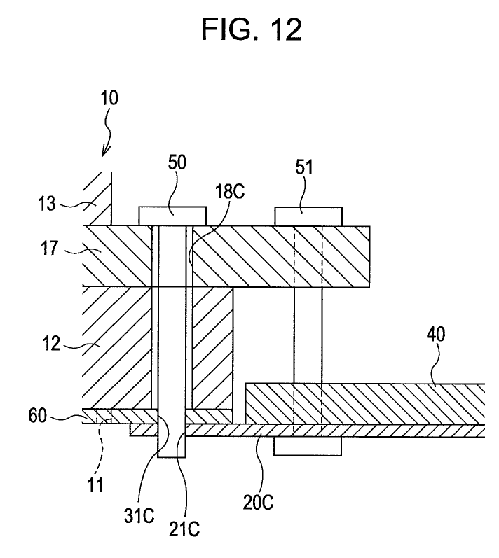

FIG. 11 is a sectional view illustrating a head unit according to Embodiment 3. The same reference numerals are given to the same constituent elements as those of Embodiments 1 and 2, and the repeated description is omitted.

As illustrated, first marks 21B serving as the first references are formed in a platform 20B. Second marks 31B serving as the second references are formed in the reference members 30B, respectively.

In the reference members 30B, the second marks 31B are formed at a predetermined position decided on the basis of at least two nozzle openings 11 of the nozzle rows 14 by photolithography, respectively. The predetermined position decided on the basis of at least two nozzle openings 11 of the nozzle rows 14 refers to a position which is away from at least two nozzle openings 11 of the nozzle rows 14 by a predetermined distance in the X and Y directions in a plan view of the head 10 from the nozzle rows 14. The predetermined distance is common to all of the heads 10. Therefore, as described below, when second marks 31B are positioned to the first marks 21B, the nozzle rows 14 are arranged while maintaining a relative position relationship between the first marks 21B.

The second mark 31B is an example of an area formed opposite to an ink ejection direction from the nozzle openings 11 of the head 10 and is formed the reference member 30B in which the flange 17 is formed. That is, the second marks 31B are not flush with a nozzle surface of the nozzle rows 14. Therefore, spaces are formed on the sides of the nozzle rows 14 of the head 10 and below a support board 40. In the ink jet printing apparatus including the head unit 1, for example, these spaces can be used as a space where a member such as a roller included in a sheet discharging mechanism is disposed. With such a configuration, a gap between a sheet and the nozzle surface is prevented from becoming wide when the member is interposed in the gap. Moreover, by keeping this gap narrow, high precision printing can be performed.

The second marks 31B are formed by forming a photoresist pattern with openings at the predetermined positions decided on the basis of at least two nozzle openings 11 of the nozzle rows 14 on the reference member 30, and then etching the photoresist pattern.

In the platform 20B, the first marks 21B are formed on the platform 20 at predetermined positions by photolithography. Here, the fact that the first marks 21B are formed at the predetermined positions means that when the second marks 31B are positioned to the first marks 21B, the first marks 21B are formed in the platform 20B so that the relative position of the plurality of heads 10 becomes a predetermined arrangement state. That is, when the first marks 21B are formed at the predetermined position and the second marks 31B are positioned to the first marks 21B, the heads 10 are mounted on the platform 20B in the predetermined arrangement state. At this time, since the second marks 31B are formed on the basis of at least two nozzle openings 11 of the nozzle rows 14, as described above, the nozzle rows 14 are arranged, while maintaining the relative position of the heads 10.

The first marks 21B are formed by forming a predetermined photoresist pattern by photolithography on the platform 20B formed of a silicon plate-shaped member, and then etching the photoresist pattern.

The first marks 21B have the same shape as that of the second marks 31B. Here, the fact the first marks 21B have the same shape as that of the second marks 31B means that the first marks 21B accord with the second marks 31B in a plan view. In this embodiment, the first marks 21B and the second marks 31B are formed by making circular through-holes with the same diameter in the platform 20B and the reference members 30B by photolithography.

Each head 10 is fixed to the platform 20B provided with the first marks 21B in a state where the second marks 31B accord with the first marks 21B in a plan view.

Since the first marks 21B and the second marks 31B are formed by photolithography, as described above, a size tolerance is smaller, compared to a case of forming resin by injection molding. Accordingly, when the second marks 31B accord with the first marks 21B, the head 10 can be disposed at the predetermined position of the platform 20B.

The second marks 31B are formed on the basis of at least two nozzle openings 11 of the nozzle rows 14. Therefore, when the second marks 31B are positioned to the first marks 21B, the nozzle rows 14 are also positioned to the first marks 21B with high precision. Accordingly, due to this positioning, the relative position of the nozzle rows 14 of the head 10 can be regulated with high precision.

In the head unit 1 according to this embodiment, as described above, the positioning of each head 10 to the platform 20B can be performed with high precision and with ease just by inserting the head 10 into the holding hole 22 and the board-side holding hole 42 and then allowing the second marks 31B to accord to the first marks 21B. In a known example, when the head 10 is positioned at the predetermined position, fine adjustment is required using an actuator device or an alignment mask. However, in the head unit 1 according to this embodiment, these devices or the process are not required. Moreover, since the alignment mechanisms used in the known example are not required in the head unit, the size of the head unit 1 can be reduced. Due to the facilitation of the positioning, a work for replacing the head 10 can be carried out easily in a place where the liquid ejection apparatus including the head unit 1 is used. That is because the head 10 is positioned with high precision and then can individually be replaced without exchanging the head unit 1.

### Embodiment 4

In Embodiments 1 to 3, the second reference is formed in the flange 17 or the like. However, the invention is not limited thereto. The second reference may be formed of a nozzle plate provided with the nozzle openings.

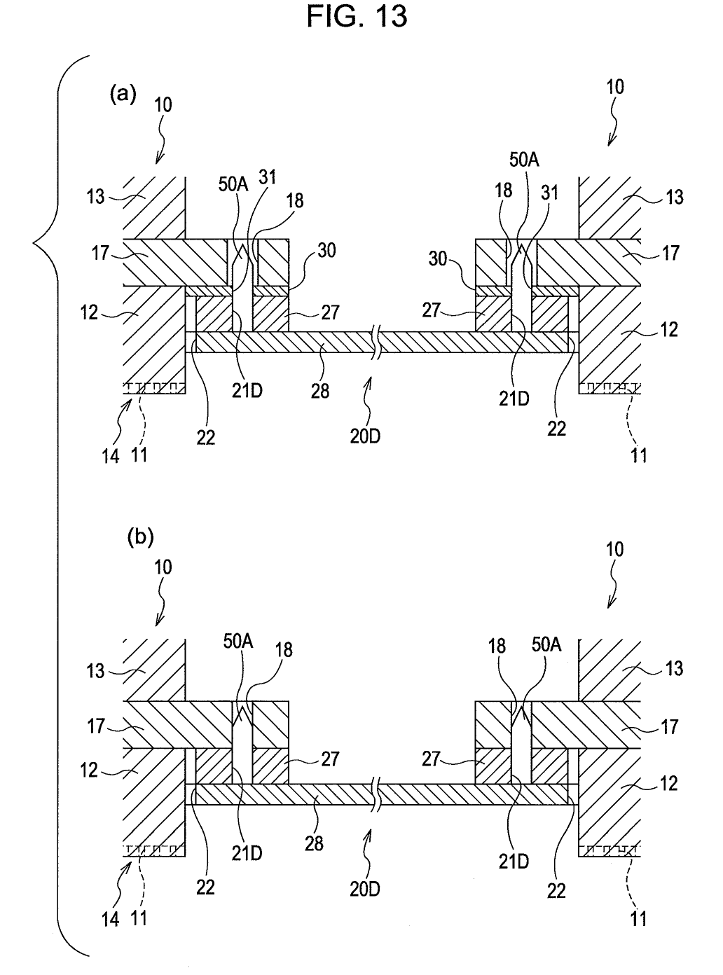

FIG. 12 is a sectional view illustrating the main elements of a head unit according to Embodiment 4 of the invention. The same reference numerals are given to the same constituent elements of Embodiments 1 to 3, and the repeated description is omitted.

As illustrated, the head 10 is provided with a nozzle plate 60 having the nozzle rows 14 formed by photolithography. A second reference hole 31C, which is an example of the second reference, is formed in the nozzle plate 60 by photolithography. Specifically, the second reference hole 31C is formed at a predetermined position decided on the basis of at least two nozzle openings 11 of the nozzle rows 14. The predetermined position decided on the basis of at least two nozzle openings 11 of the nozzle rows 14 refers to a position which is away from at least two nozzle openings 11 of the nozzle rows 14 by a predetermined distance in the X and Y directions in a plan view of the head 10 from the nozzle rows 14. The predetermined distance is common to all of the heads 10. Therefore, as described below, when second reference hole 31C is positioned to the first reference hole 21C, the nozzle rows 14 are arranged while maintaining a relative position relationship between the first reference holes 21C.

The second reference hole 31C is formed by forming a photoresist pattern with each opening having the same shape as that of the first reference hole 21C at the predetermined position decided on the basis of at least two nozzle openings 11 of the nozzle rows 14 on the nozzle plate 60, and then etching the photoresist pattern. The shape of the opening of the second reference hole 31C is circumscribed with the outer circumferential surface of a positioning pin 50, when the positioning pin 50 is inserted into the opening.

In the platform 20C, two first reference hole 21C (first reference) is formed for each head 10 at a predetermined position by photolithography. Here, the fact that the first reference holes 21C are formed at the predetermined positions means that when the second reference holes 31C are positioned to the first reference holes 21C, the first reference holes 21C are formed in the platform 20C so that the relative position of the plurality of heads 10 becomes a predetermined arrangement state. That is, when the first reference holes 21C are formed at the predetermined positions and the second reference holes 31C are positioned to the first reference holes 21C, the heads 10 are mounted on the platform 20C in the predetermined arrangement state. At this time, since the second reference holes 31C are formed in the nozzle plate 60 on the basis of at least two nozzle openings 11 of the nozzle rows 14, as described above, the nozzle rows 14 are arranged, while maintaining the relative position of the heads 10.

The first reference holes 21C are formed by forming a predetermined photoresist pattern by photolithography on the platform 20C formed of a silicon plate-shaped member, and then etching the photoresist pattern. The opening shape of the first reference hole 21C and the opening shape of the second reference hole 31C refer to the shape circumscribed with the outer circumferential surface of the positioning pin 50, when the positioning pin 50 is inserted. As described in Embodiment 1, the opening shape of the first reference hole 21C or the second reference hole 31C may be formed so that the movement in the radial direction of the inserted positioning pin 50 is regulated.

An insertion hole 18C communicating with the second reference hole 31C is formed in the head main body 12 and the flange 17. The positioning pin 50 is inserted into the insertion hole 18C, the second reference hole 31C, and the first reference hole 21C. Each head 10 and the platform 20C are fixed to each other by a fixing screw 51.

As described above, the opening shape of the first reference hole 21C is the same as the opening shape of the second reference hole 31C. The inner circumferential surfaces of the first reference hole and the second reference hole come in contact with the outer circumferential surface of the positioning pin 50. On the other hand, since the first reference hole 21C and the second reference hole 31C are formed by photolithography, the size tolerance is smaller, compared to a case of forming resin by injection molding. Accordingly, when the positioning pin 50 is inserted into the first reference hole 21C and the second reference hole 31C, the first reference hole 21C and the second reference hole 31C are positioned with high precision. As a consequence, each head 10 can be disposed at the predetermined position of the platform 20C with high precision.

The second reference hole 31C is formed on the basis of at least two nozzle openings 11 of the nozzle rows 14. Therefore, when the second reference hole 31C is positioned to the first reference hole 21C, the nozzle rows 14 are also positioned to the first reference hole 21C with high precision.

In particular, in this embodiment, since the second reference hole 31C is formed in the nozzle plate 60, the nozzle opening 11 and the second reference hole 31C can simultaneously be formed. Therefore, the second reference hole 31C can reasonably be formed. Since the nozzle plate 60 is mounted directly on the platform 20C, the relative position relationship between the nozzle rows 14 of each head 10 can be determined with more precision, compared to a case where the second reference hole 31C is formed in the reference member 30 or the like.

### Embodiment 5

FIG. 13 is a sectional view illustrating a head unit according to Embodiment 5. The same reference numerals are given to the same constituent elements as those of Embodiment 1, and the repeated description is omitted.

As shown in (a) of FIG. 13, the platform 20D has a positioning member 27, which is an example of a member including first reference holes 21D (first reference) and formed in every head 10. The positioning member 27 is mounted on the platform board 28. The platform 20D is constituted by the positioning member 27 and the platform board 28.

In this embodiment, two positioning members 27 are formed in every head 10 and the positioning member 27 is mounted on the platform board 28 so as to face the flange 17 of the head 10 inserted into the holding hole 22.

The positioning members 27 are made of silicon. The first reference holes 21D are made by forming a predetermined photoresist pattern on the surface of the positioning members and etching the photoresist pattern. Likewise, the reference members 30 are made of silicon. The second reference holes 31 are made by forming a predetermined photoresist pattern on the surface of the reference members by photoresist pattern by photolithography and etching the photoresist pattern. The first reference hole 21D and the second reference hole 31 have an opening shape to which a positioning pin 50A, which is described below, is fitted.

The platform board 28 is made of metal such as SUS. The holding hole 22 (not shown) into which the side of the nozzle rows 14 of the head 10 is inserted and a female screw (not shown) to which the fixing screw 51 (see FIG. 3) is inserted are formed in the platform board.

The platform 20D is formed by mounting the positioning members 27 on the platform board 28 so that the relative position between the first reference holes 21D becomes a predetermined arrangement state. The platform 20D can be formed by mounting the positioning members 27 on the platform 28 so as to align the position of the first reference holes 21D to references by the use of a glass mask with the references, each of which is used to regulate the first reference hole 21D, for example. In this embodiment, the positioning members 27 are mounted by inserting the positioning pins 50A into the first reference holes 21D to be fixed to the platform board 28 so as to align with the references of the glass mask.

The side of the nozzle rows 14 is inserted into the holding hole 22 so that each head 10 protrudes in the ink ejection direction more than the platform board 28, and the flanges 17 are placed on the positioning members 27 with the reference members 30 interposed therebetween, respectively. The positioning pins 50A are inserted into the first reference holes 21D and the second reference holes 31. When the positioning pins 50A are inserted into the first reference holes 21D and the second reference holes 31, the second reference holes 31 are positioned to the first reference holes 21D.

The fixing screws 51 (see FIG. 3) are inserted into the mounting holes 19 and the mounting holes 32 (see FIG. 2) to be fixed to the platform board 28, each head 10 placed on the positioning members 27 is fixed to the platform 20D with the reference members 30 interposed therebetween.

In this way, when the head 10 is placed on the platform 20D and the second reference holes 31 are positioned to the first reference holes 21D, the head 10 is mounted on the platform 20D in a state where the relative position between the first reference holes 21D is maintained. Since the second reference holes 31 are formed on the basis of at least two nozzle openings 11 of the nozzle rows 14, as described in Embodiment 1, the nozzle rows 14 are also arranged while the relative position with the head 10 is maintained.

The second reference holes 31 are an example of an area formed opposite to an ink ejection direction from the nozzle openings 11 of the head 10 and are formed in the reference members 30 formed in the flanges 17, respectively. That is, the second reference holes 31 are not flush with a nozzle surface of the nozzle rows 14. Therefore, spaces are formed on the sides of the nozzle rows 14 of the head 10 and below the platform board 28. In the ink jet printing apparatus including the head unit 1, for example, these spaces can be used as a space where a member such as a roller included in a sheet discharging mechanism is disposed. With such a configuration, a gap between a sheet and the nozzle surface is prevented from becoming wide when the member is interposed in the gap. Moreover, by keeping this gap narrow, high precision printing can be performed.

Since the first reference holes 21D and the second reference holes 31 are formed by photolithography in the head unit 1 according to this embodiment, as described above, a size tolerance is smaller, compared to a case of forming resin by injection molding. Accordingly, by positioning the second reference hole 31 to the first reference hole 21D through the positioning pin 50A, each head 10 can be disposed at the predetermined position of the platform 20D with high precision. The second reference hole 31 is formed on the basis of at least two nozzle openings 11 of the nozzle rows 14. Therefore, when the second reference hole 31 is positioned to the first reference hole 21D through the positioning pin 50A, the nozzle rows 14 are also positioned to the first reference hole 21D with high precision. Accordingly, due to this positioning, the relative position of the nozzle rows 14 of the head 10 can be regulated with high precision.

In this embodiment, since the platform 20D has the positioning members 27 to which the positioning pins 50A are fixed in advance, each head 10 can be positioned on the platform 20D with high precision just by inserting the positioning pins 50A in to the second reference holes 31 of the head 10. Moreover, since the adjustment by a known adjustment mechanism is not necessary, the time necessary to mount each head 10 can be shortened. Since each head 10 can be mounted on the platform 20D just by inserting the positioning pins 50A, the head 10 can easily be replaced.

Since the first reference hole 21D is formed in the positioning member 27 disposed in each of the head 10, the degree of freedom with which the first reference holes 21D are mounted on the platform board 28 is improved. That is, by adjusting the arrangement of the positioning members 27, the relative position between the first reference holes 21D can be adjusted. Accordingly, the relative position between the heads 10 can easily be adjusted depending on the use or the goal. For example, when the head unit 1 needs to perform printing with high precision, this goal can be achieved by mounting the positioning members 27 on the platform board 28 so that the nozzle openings 11 of the nozzle rows 14 of certain heads 10 are located between the nozzle openings 11 of the nozzle rows 14 of other heads 10. When the plurality of first reference holes is formed in one board, it is necessary to position the plurality of first reference holes on another board by photolithography upon every fine adjustment. In this embodiment, however, the plurality of first reference holes may be formed just by adding the positioning members 27 provided with the first reference holes 21D to the platform board 28, re-arranging the positioning members, or detaching the positioning members 27 from the platform board.

When all of the first reference holes 21D are formed in one member, the platform of one head unit 1 is just formed from one member. Therefore, there is a non-use area where the first reference holes 21D are not formed in the member. In this embodiment, however, since the plurality of positioning members 27 provided with the first reference hole 21D can be formed from one member, there is no non-use area. Accordingly, since the number of positioning members 27 can be increased in the head unit 1 according to this embodiment, it is possible to reduce the cost.

Since the positioning members 27 are individually formed in each of the heads 10, distortion caused due to a difference of the coefficient of linear expansion with the platform board 28 hardly occurs in the platform board. The deformation or the position deviation of the first reference holes 21D can be prevented. Even though it is necessary to exchange the positioning member 27 due to damage or abrasion, it is not necessary to exchange the platform 20D. Only the damaged positioning member 27 may be exchanged. Accordingly, the cost required to exchange the damaged positioning member can be reduced, compared to the case of exchanging the platform 20D.

Like the head unit 1 according to Embodiment 1, since the alignment mechanisms used in the known example are not required in the head unit according to this embodiment, the size of the head unit 1 can be reduced. A work for replacing the head 10 can be carried out easily in a place where the liquid ejection apparatus including the head unit 1 is used. That is because the head 10 is positioned with high precision and then can individually be replaced without exchanging the head unit 1.

In this embodiment, the positioning pin 50A is fixed to the positioning member 27, but the invention is not limited thereto. The positioning pin may be inserted into the second reference hole 31 of the reference member 30 to be fixed. Alternatively, the positioning pin 50A is not required to be fixed in advance to one of the positioning member 27 or the reference member 30. After the first reference hole 21D is positioned to the second reference hole 31, the positioning pin 50A may be inserted. Moreover, when the positioning pin 50A is fixed to the platform 20D, only the second reference hole 31 of the head 10, which can be exchanged, is worn by the positioning pin 50A due to the mounting of each head 10 on the platform 20D. Accordingly, the platform 20D, which is not an exchange target, can be prevented from being damaged or the like due to the replacement of the head 10.

The platform 20D may have a support board or a board joined to a side opposite to the positioning members 27 of the platform board 28 may be used as a platform. Alternatively, a board formed by mounting the positioning members 27 on a support board may be used as the platform 20D.

The positioning member 27 and the reference member 30 are made of silicon, but the invention is not limited to a material as long as the first reference hole 21D and the second reference hole 31 can be made of the material. Examples of the material include metal such as SUS and an etching material such as glass.

The above-describe second reference holes 31 are formed by photolithography, but may not necessarily be formed by the photolithography. A head unit formed when only the first reference holes 21D are formed by photolithography will be described with reference to (b) of FIG. 13.

As illustrated, no reference member 30 is formed in the flange 17 of the head 10. Instead, the insertion hole 18 of the flange 17 serves as the second reference. The positioning pin 50A is inserted into the insertion hole 18, the first reference hole 21D, and the insertion hole 18. Even in this case, since the insertion holes 18 are positioned to the first reference holes 21D formed by photolithography through the positioning pins 50, the head 10 can be mounted on the platform 20D with high precision, even though each head cannot be mounted with the high precision to the degree that the reference member 30 with the second reference hole 31 is disposed.

When the same reference surface as that of Embodiment 2 is used as the first reference, the side surface of the positioning member 27 according to this embodiment may be used as the first reference surface formed by photolithography and the side surface of the reference member 30 may be likewise used as the second reference surface formed by photolithography. Even in this case, the same advantaged obtained when the first reference holes 21D are formed in the positioning members 27 disposed in each head 10 can be achieved.

### Other Embodiments

The embodiments of the invention have been described, but the basic configuration of the invention is not limited to the above-described embodiments.

In Embodiments 1 to 4 described above, the platform is formed of one silicon plate, but may be formed of a plurality of silicon plates. This configuration is useful when a sufficient strength cannot be obtained with just one silicon plate.

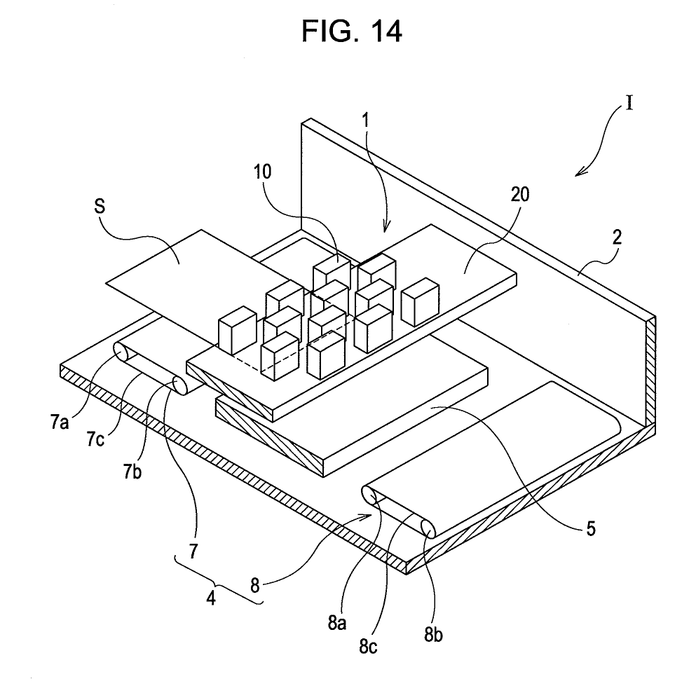

The head unit 1 according to the above-described embodiments is mounted in the ink jet printing apparatus. FIG. 14 is a schematic view illustrating an example of the ink jet printing apparatus.

As illustrated, in an ink jet printing apparatus I according to the embodiments, the head unit 1 is a so-called line type printing device which is fixed and performs printing while an ejection target medium S such as a printing sheet such as paper. Specifically, the ink jet printing apparatus I includes an apparatus main body 2 to which the head unit 1 is fixed, a transport unit 4 which transports the ejection target medium S, and a holding unit 5 which is disposed so as to face the head unit 1 with the ejection target medium S interposed therebetween and holds the ejection target medium S.

In the head unit 1, the plurality of ink jet printing heads 10 are arranged in a direction intersecting the transport direction of the ejection target medium S. Specifically, in the ink jet printing head 10, the nozzle rows 14 in the range of one row to a plurality of rows in which the plurality of nozzle openings 11 are formed are formed. In the ink jet printing head 10, the nozzle openings 11 are arranged in the direction intersecting the transport direction of the ejection target medium S. The plurality of ink jet printing heads 10 are arranged in the direction intersecting the transport direction of the ejection target medium S and are disposed at the positions slightly deviated in the transport direction so that the nozzle rows 14 are arranged continuously in the direction intersecting the transport direction of the ejection target medium. In the example shown in FIG. 14, the transport direction of the ejection target medium S is the second direction and the direction intersecting the transport direction of the ejection target medium S is the first direction in the head unit 1.

Even though not illustrated, an ink storing unit such as an ink tank or an ink cartridge storing ink is connected to each ink jet printing head 10 of the head unit 1 so as to supply the ink. The ink storing unit may be disposed on the head unit 1 or may be disposed at a position different from that of the head unit 1 within the apparatus main body 2, for example.

The transport unit 4 includes a first transport unit 7 and a second transport unit 8 which are disposed on both the sides of the head unit 1 in the transport direction of the ejection target medium S.

The first transport unit 7 includes a driving roller 7a, a driven roller 7b, and a transport belt 7c winding the driving roller 7a and the driven roller 7b. The second transport unit 8 includes a driving roller 8a, a driven roller 8b, and a transport belt 8c, like the first transport unit 7.

A driving unit such as a driving motor (not shown) is connected to each of the driving rollers 7a and 8a of the first transport unit 7 and the second transport unit 8, respectively. The transport belts 7c and 8c are rotatably driven by a driving force of the driving unit so as to transport the ejection target medium S to the upstream side and the downstream sides of the head unit 1.

In this embodiment, the first transport unit 7 and the second transport unit 8 including the driving rollers 7a and 8a, the driven rollers 7b and 8b, and the transport belts 7c and 8c, respectively are exemplified, but holding units for holding the ejection target medium S on the transport belts 7c and 8c may be disposed, respectively. For example, a charging units for charging the outer circumferential surface of the ejection target medium S may be used as the holding units. The ejection target medium S charged by the discharging unit may be adsorbed on the transport belts 7c and 8c by charge polarization. Alternatively, as the holding units, pressure rollers may be disposed on the transport belts 7c and 8c to interpose the ejection target medium S between the pressure rollers and the transport belts 7c and 8c, respectively.

The holding unit 5 is disposed so as to face the head unit 1 between the first transport unit 7 and the second transport unit 8. The holding unit 5 holds the ejection target medium S transported by the first transport unit 7 and the second transport unit 8 at the position facing the head unit 1.

The holding unit 5 is provided with an adsorbing unit for adsorbing the transported ejection target medium S on the holding unit 5. Examples of the adsorbing unit includes a unit for adsorbing the ejection target medium S in a suction manner and a unit for adsorbing the ejection target medium S in an electrostatic manner.

In the above embodiment, the head unit 1 is fixed to the apparatus main body 2 so that the transport unit 4 transports the ejection target medium S. However, since the transport unit 4 relatively transports the ejection target medium S with respect to the ink jet printing head 10, the ejection target medium S may be fixed and the transport unit 4 may transport the head unit 1. The plurality of ink jet printing heads 10 may be disposed also in the direction intersecting the transport direction of the ejection target medium S. In this case, in the state where the ejection target medium S is fixed without transporting the ejection target medium, the entire ejection areas of the ejection target medium S may be subjected to the printing by the fixed ink jet printing heads 10. That is, the above-described transport unit 4 may not be disposed in effect. Of course, the above-described head unit 1 may be mounted on a so-called serial type printing apparatus in which the head unit 1 is disposed so as to move in the direction intersecting the transport direction and performs printing while moving the head unit 1 in the direction intersecting the transport direction. The invention is applicable broadly to all kinds of liquid ejection head units. For example, the invention is applicable to a printing head unit such as various kinds of ink jet printing units used in an image printing apparatus such as a printer, a color material ejection head unit used to manufacture a color filter such as a liquid crystal display, an electrode material ejection head unit used to form an electrode such as an organic EL display or an FED (Field Emission Display), a bio organism ejection head unit used to manufacture a bio chip, and the like.

The ink jet printing apparatus I has been described as an example of the liquid ejecting apparatus, but the invention is applicable to a liquid ejection apparatus using liquid ejection head units different from the above-described head unit.

1. A liquid ejection head unit comprising:
liquid ejection heads which each have a nozzle row in which a plurality of nozzle openings is arranged; and
a platform which is mounted with the plurality of liquid ejection heads,
wherein the platform includes a first reference which is formed in each of the liquid ejection heads by photolithography and to which the liquid ejection head is positioned.

2. The liquid ejection head unit according to claim 1, wherein the platform includes a member which is provided with the first reference and formed in each of the liquid ejection heads.

3. The liquid ejection head unit according to claim 1, wherein in the liquid ejection head, a second reference which is positioned to the first reference is formed by photolithography.

4. The liquid ejection head unit according to claim 3, wherein the second reference is formed at a position decided on the basis of at least two nozzle openings of the nozzle rows.

5. The liquid ejection head unit according to claim 3,
wherein the liquid ejection head has a nozzle plate in which the nozzle row is formed by photolithography, and
wherein the second reference is formed in the nozzle plate by photolithography.

6. The liquid ejection head unit according to claim 1,
wherein the first reference is a first reference hole formed by photolithography, and
wherein a positioning pin is inserted into an insertion hole formed in the liquid ejection head and the first reference hole.

7. The liquid ejection head unit according to claim 3,
wherein the first reference and the second reference are a first reference hole and a second reference hole formed by photolithography, respectively, and
wherein a positioning pin is inserted into the first reference hole and the second reference hole.

8. The liquid ejection head unit according to claim 1,
wherein the first reference is a first reference surface formed by photolithography, and
wherein a surface of the liquid ejection head comes in contact with the first reference surface.

9. The liquid ejection head unit according to claim 3,
wherein the first reference and the second reference are a first reference surface and a second reference surface formed by photolithography, respectively, and
wherein the first reference surface comes in contact with the second reference surface.

10. The liquid ejection head unit according to claim 3, wherein the second reference is formed in an area opposite to a liquid ejection direction from the nozzle openings of the liquid ejection head.

11. The liquid ejection head unit according to claim 1, wherein the platform has a support board made of metal.

12. The liquid ejection head unit according to claim 1, wherein the platform is made of metal.

13. A liquid ejection apparatus comprising the liquid ejection head unit according to any one of claims 1 to 12.

14. A method for manufacturing a liquid ejection head unit including liquid ejection heads which each have a nozzle row in which a plurality of nozzle openings is arranged and a platform which is mounted with the plurality of liquid ejection heads, the method comprising:
forming a first reference in the platform for each of the liquid ejection heads by photolithography; and
positioning the plurality of liquid ejection heads to the first references to mount the liquid ejection heads on the platform.
